(19) United States
(12) Patent Application Publication
(10) Pub. No.: US 2008/0275894 A1
(43) Pub. Date: Nov. 6, 2008

(54) CONTENT ITEM APPARATUS AND METHOD OF OPERATION THEREFOR

(75) Inventors: Patricia M. Charlton, London (GB); Jonathan S. Teh, Basingstoke (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/743,903

(22) Filed: May 3, 2007

(51) Int. Cl. G06F 7/08

(52) U.S. Cl. 707/101; 707/E17.009

(57) ABSTRACT

A content item apparatus comprises a content data receiver (201) for receiving first context data and first content characterising data for a content item. A decision structure processor (205) provides a content handling decision structure associating context data and content characteristics data with content handling executable actions in response to a user preference profile. The content handling decision structure also reflects allowable interrelations between content handling actions. An inference processor (203) generates a set of executable handling actions for the content item by evaluating the content handling decision structure in response to the first context data and the first content characterising data and a device distribution interface (209) generates content handling data for the content item where the content handling data comprises the set of executable actions. An exception processor (217) may override actions of the inference processor (203) in response to exception rules. The invention may provide improved automated content handling.

### FIELD OF THE INVENTION

The invention relates to a content item apparatus and method of operation therefor and in particular, but not exclusively, to a system for automatically generating executable data describing a preference for handling of a content item.

### BACKGROUND OF THE INVENTION

The emergence and increasing popularity of communication systems such as the Internet, cellular communication systems and wired and wireless computer networks have led to a substantially increased distribution of digital content between users by means of data communication. For example, it is today commonplace for content items such as music and photos to be digitally encoded and distributed e.g. via the Internet.

Furthermore, the generation, sharing and distribution of content by individual consumers has increased explosively and currently a large percentage of the population frequently generate digital content items such as for example digital photos, digitally encoded printed material (such as word processing document or PDF documents) or digitally encoded music.

Also, users increasingly use a number of different consumer devices for storing, manipulating and presenting content items. For example, a user's photos may be viewed and/or stored on a portable computer, a music player, a personal digital assistant, a home game console, a portable game device, a mobile phone etc.

Thus, it is becoming increasingly difficult and cumbersome for a user to manage an increasingly large content collection over an increasingly diverse range of content devices.

To facilitate automated and technical management of content data, more and more applications use some form of metadata to perform some tracking of information and automation of certain types of tasks or to provide further information of content characteristics of the content item. For example, digital photos often comprise metadata indicating when the picture was taken and what parameters were used and may also include content data e.g. listing people included in the photograph.

Thus, it would be advantageous to increasingly allow content item management to be provided by automated technical means rather than require a manual management and organisation by the user. However, technical solutions to such problems tend to be suboptimal and tend to be complex, difficult to implement and to provide a management that does not sufficiently accurately reflect the user's preferences.

Hence, an improved system for automatically managing and handling content items would be advantageous and in particular a system allowing increased flexibility, improved correspondence with user preferences, facilitated implementation, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of generating content handling data for a content item, the method comprising: receiving first context data and first content characterising data for a content item; providing a content handling decision structure associating context data and content characteristic data with content handling executable actions in response to a user preference profile, the content handling decision structure furthermore reflecting allowable interrelations between content handling actions; generating a set of executable handling actions for the content item by evaluating the content handling decision structure in response to the first context data and the first content characterising data; and generating content handling data for the content item, the content handling data comprising the set of executable actions.

The invention may allow improved automated or semi-automated management of content items. In particular, the invention may allow different devices to simply and automatically manage content items based on the generated handling data. For example, the individual devices may execute the appropriate actions defined by the executable actions of the handling data without requiring them to individually evaluate the user preferences, context data, content data etc. Furthermore, handling data which specifies the handling actions which are required, preferred or allowed for the content item can be determined to closely reflect the user preferences and to correspond to the actions that would be manually performed by the user.

The invention allows complex and detailed handling actions to be generated for individual content items. A complex inference system may be used to generate such data e.g. based on previous actions. The system may be a learning system which dynamically modifies itself to match the user's preferences and changing conditions. A high degree of adaptation of the preferences to the specific characteristics and circumstances of the individual content item can be achieved while at the same time ensuring that the generated handling data and executable handling actions are consistent and compatible.

The handling data may include a representation of allowable, required and/or preferred executable handling actions. An executable handling action may be an action performed on a content item which does not alter the content of the content item. The executable handling actions may for example include a communication, storage, distribution, presentation (e.g. displaying or playing), moving, copying or deletion of the associated content item.

According to another aspect of the invention there is provided a content item apparatus comprising: means for receiving first context data and first content characterising data for a content item; means for providing a content handling decision structure associating context data and content characteristic data with content handling executable actions in response to a user preference profile; the content handling decision structure furthermore reflecting allowable interrelations between content handling actions; means for generating a set of executable handling actions for the content item by evaluating the content handling decision structure in response to the first context data and the first content characterising data; and means for generating content handling data for the content item, the content handling data comprising the set of executable actions.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a content item system comprising a content apparatus device in accordance with some embodiments of the invention;

FIG. 2 illustrates an example of a content apparatus device in accordance with some embodiments of the invention; and

FIG. 3 illustrates a method of generating content handling data for a content item in accordance with some embodiments of the invention.

### DETAILED DESCRIPTION OF SOME EMBODIMENTS OF THE INVENTION

The following description focuses on embodiments of the invention applicable to a content item apparatus in the form of a docketing device for a portable device such as a mobile computer, mobile phone, mobile gaming device etc. However, it will be appreciated that the invention is not limited to this application but may be applied to many other content item apparatuses including for example mobile or stationary content generation, processing, storing or presenting devices including for example computers, cameras, mobile phones, personal digital assistants, gaming devices etc.

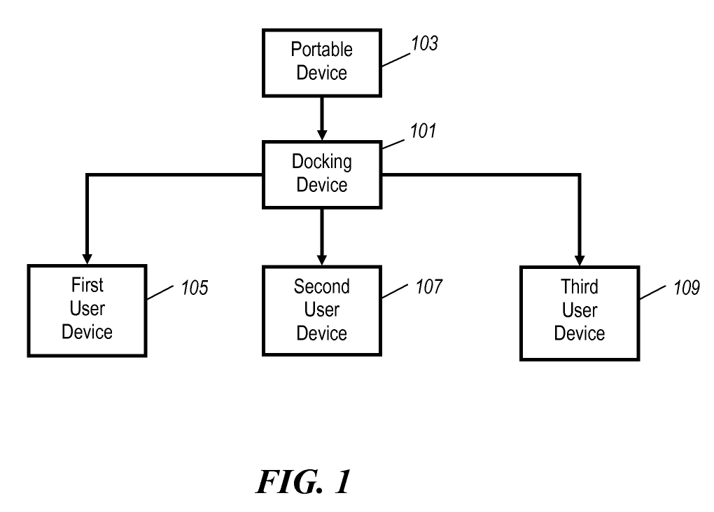

FIG. 1 illustrates an example of a content item system comprising a docking device 101 in accordance with some embodiments of the invention. The docking device 101 is arranged to receive a separate and removable portable device 103. For example, the portable device 103 may be a mobile phone comprising a camera for recording still or moving images, a display for presenting images, a microphone for recording audio clips and speakers or headphones for presenting music audio clips. When the portable device is inserted in the docking device 101 an electrical connection is made allowing the portable device 103 and the docking device 101 to exchange data. Specifically, the portable device 103 can download the stored content items to the docking device 101 which may store these in internal memory. For example, when the portable device 103 is coupled to the docking device 101, all digital photos, music files etc stored in the mobile phone are downloaded to the docking device 101.

The docking device 101 is coupled to a plurality of user devices of which three 105-109 are shown. The user devices 105-109 may include all content devices owned by a single user. For example, the devices may include the user's computers, gaming devices, digital music players, personal video recorders etc. It will be appreciated that not all user devices may necessarily be coupled to the docking device 101 at any given time but that the couplings between the docking device 101 and the user devices 105-107 may be dynamically established and terminated as appropriate. The coupling between the docking device 101 and the user devices 105-109 may for example be direct electrical connections and/or may e.g. be via a network such as a Wireless Local Area Network.

The docking device 101 comprises means for automatically generating executable data determining how the content items from the portable device 103 is to be handled. The executable data comprises executable handling actions to be used by the docking device 101 and/or each of the user devices 105-107 to automatically handle the data in accordance with the user's preferences and current conditions. The executable handling actions correspond to actions which are performed with the content item but which do not alter the content of the content item and may for example include deleting, moving, copying, presenting, distributing and transmitting the content item.

Specifically, the docking device 101 comprises an inference mechanism which can evaluate a content handling decision structure in response to context data and content characterising data for each content item in order to generate executable data which defines how the content item may, must or preferably should be handled by the docking device 101 and/or the user devices 105-109.

Thus, the docking device 101 uses an inferencing mechanism which is applied to data representing the content item in order to generate data that can be used to automatically organise and distribute the data. Furthermore, the inferencing is based on a content handling decision structure which in the embodiment is constructed for the specific content item and which not only reflects user preferences but also interrelations between different content item handling actions, thereby inherently ensuring that the generated handling data is consistent. Also, data is generated which may easily be shared and re-used by different devices and which allows a high degree of customisation and simple yet complex interworking between the different devices.

Specifically, the docking device 101 comprises functionality that can provide an automated organisation of individual content items from the portable device 103. This organisation can include an automated distribution of content items to individual user devices followed by specific operations being performed by these user devices. The system can provide complex systems of executable actions specifically generated for the individual items.

Some specific clarifying examples may e.g. include:
all photos taken during work hours are copied to the first user device 105 (e.g. the user's portable work computer) where they are stored in the folder c:/work photos whereas other photos are copied to the second user device 107 (e.g. another user's portable work computer) where they are stored in the folder c:/photos.
digital music files belonging to a classical category should be sent to the third user device if today is a weekend and to the first user device if it is a weekday. The appropriate user device should present the music clips in headphones during work hours and in loudspeakers outside work hours.

It will be appreciated that these examples are merely simple examples provided for clarity and brevity and that the system may generate executable data corresponding to very complex processing involving a large number of devices and actions.

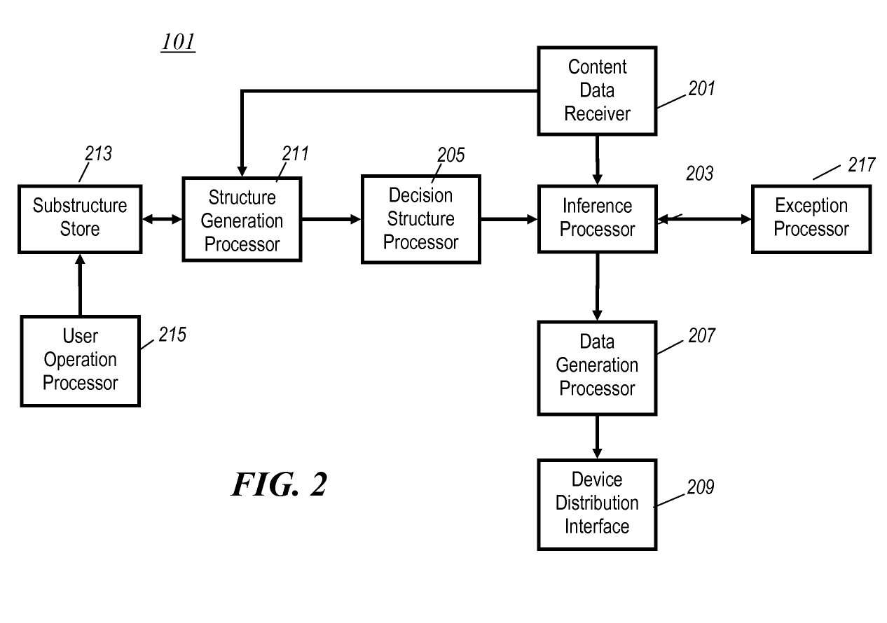

FIG. 2 illustrates the docking device 101 in more detail. The docking device 101 comprises a content data receiver 201 which receives data associated with the content items stored in the portable device 103. Specifically, for each content item, context data and content characterising data is received. The context data provides information relating to circumstances associated with the content item such as time of creation, location when created, weather characteristics, the device that created the content item etc. The content characterising data provides information relating to the content of the content item, such as for example people included in a photo, the musical instruments used in a music clip etc. The context and content characterizing data may specifically be metadata generated automatically or manually when the content item was created.

The content data receiver 201 is coupled to an inference processor 203 which is furthermore coupled to a decision structure processor 205. The decision structure processor 205 generates a content handling decision structure which is used by an inference algorithm of the inference processor 203 to generate executable handling actions for the content item.

The content handling decision structure associates context data and content characteristics data with content handling executable actions depending on user preferences. Specifically, a user preference profile is maintained for the user and used to determine the individual decisions of the content handling decision structure. For example, if a user has a preference for storing specific music clips on a specific device, the content handling decision structure may include a decision evaluating whether the content item matches the characteristics and if so defining a handling action specifying that the content item should be copied or moved to that device.

It will be appreciated that the user preference profile need not be stored or generated separately from the content handling decision structure but may be integrated therewith. For example, the user preferences may be embedded in the content handling decision structure and may specifically be embedded in the individual decisions.

The user preference profile may for example include a number of separate preference values, such as e.g.
music should be stored on device A
photos should be stored on device B
photos should be shown on device B except for weekends when it should be shown on device C
photos should be deleted after a month without being viewed
rock music should be played in headphones whereas classical music should be played in loudspeakers
etc.

In addition to the user preferences, the content handling decision structure furthermore reflects allowable interrelations between the content handling actions. Specifically, the content handling decision structure is structured such that a given decision resulting in one executable action blocks all paths/decisions in the decision structure which are in conflict with this action. For example, a decision resulting in an executable action to move the content item to only one location will block all decisions that will result in an executable action of moving or copying the content item to another location. The priority between different mutually exclusive actions is represented by the content handling decision structure such that decisions associated with a higher prioritised action are performed before decisions with a lower prioritised action.

In the specific example, the content handling decision structure is a hierarchical tree based decision structure wherein a plurality of nested decisions are made. At any given node a decision may be made depending on the specific context or content characterising data. For example, a node of the content handling decision structure may comprise decisions such as:

If the content item is a rock music clip then generate an executable action specifying that the content item preferably should be (or must be or may be) presented in headphones and proceed along branch A;

If the content item is a classical music clip then generate an executable action specifying that the content item preferably should be (or must be or may be) presented in loudspeakers and proceed along branch A;

If the content item is not a music clip then do not generate any executable action and proceed along branch B;

The next decision along branch A may then e.g. contain a decision to generate an executable action based on e.g. a record company publishing the music item whereas the next decision along branch B may comprise a decision depending on whether the content item is a text document or not. However, no subbranch of branch A will result in an executable action that a rock music content item should be presented in loudspeakers or that a classical music content item should be presented in headphones.

The decision structure processor 205 feeds the content handling decision structure to the inference processor 203 which proceeds to generate the set of executable handling actions for the content item based on the content handling decision structure and the context and content characterising data. Specifically, the inference processor 203 may sequentially step through the decision tree and can for each node select the appropriate forward branch as well as include the associated action in the action set if the conditions therefor are met for the data associated with the content item.

The generated set of actions is fed to a data generation processor 207 coupled to the inference processor 203. The data generation processor 207 generates content handling data which comprises the set of executable handling actions. The handling data thus comprises executable actions which define how the content item is handled by the devices. The data is fed to a device distribution interface 209 which evaluates the generated handling data and performs all the executable actions suitable for execution by the docking device 101. In the specific example, the device distribution interface 209 communicates the content item to the relevant user devices 105-109 by performing all executable actions specifying that the content item should be moved or copied to specific user devices. In addition, the device distribution interface 209 communicates the handling data to any user device 105-109 receiving the content item or which is otherwise required to perform an action (such as e.g. to delete a previously received copy of the content item).

The individual user devices 105-109 then proceed to process the handling data and to perform any appropriate executable actions. For example, one user device may be proceed to immediately present the content item (e.g. a digital photo display may immediately display a new photo), another device may proceed to store the content item (e.g. the new photo may be stored on a home computer) another may proceed to transmit the content item to a remote destination (e.g. a mobile phone may automatically transmit a multimedia message comprising the new photo to a specific contact). Thus, the generated handling data allows a very efficient and simple to implement distribution of actions to be performed for a content item. Furthermore, this approach allows a very high degree of flexibility and allows highly complex operations comprising many varied actions to be automatically determined and executed.

It will be appreciated that the inference mechanism can generate the executable actions in response to a variety of different data. For example, the user preference data reflected in the content handling decision structure may comprise a content distribution preference which may define the user's preferences for which user devices different content items are distributed to. Such preferences can for example include a preference that a certain type of content item is distributed to all user devices under specific conditions (e.g. all pictures of the user's baby are distributed to all devices), that a certain type of content items are moved to a single location (e.g. all video content items are only stored on the user's personal video recorder), etc.

As another example, the user preference profile may include a user contact preference. This data may for example include the user's address book(s) associated with preferences for different contacts. For example, the user's family may be associated with high preference values for pictures of the user's children thereby increasing the likelihood that an executable action is specified for sending such pictures to the family members.

As another example, the user preference profile may include a grouping preference. For example, the user preference profile may reflect a preference for the user to group certain content items together and/or to transmit specific content items to specific groups of users in specific circumstances.

The content handling decision structure may also reflect other data or information than user preference data. For example, the content handling decision structure may generate content handling actions in response to a device profile of one or more of the user devices 105-109 and/or the portable device 103. For example, the content handling decision structure may include a restriction that photos can only be moved from the portable device 103 to a specific user device if the storage capacity of the user device exceeds the size of the photos generated by the portable device. The content handling decision structure may in such an example be constructed to inherently reflect the device characteristics e.g. by only including executable actions which move the photo if indeed the storage capacity exceeds the required level.

As another example the content handling decision structure may generate content handling actions in response to a user characteristics profile. The user characteristics profile may be a profile which does not reflect the individual preferences of the specific user but rather reflects objective characteristics of the user. For example, the content handling decision structure may reflect the sex of the user, the age of the user, a home address of the user etc. This information may be used to bias the generated handling data towards the preferences typical of a user having similar characteristics as the user.

In the example, the content handling decision structure is dynamically constructed for the individual content item depending on the characteristics of the content item.

Specifically, the decision structure processor 205 is coupled to a structure generation processor 211 which generates the content handling decision structure in response to at least one of the context data and the content characteristics data for the content item. The structure generation processor 211 is coupled to a substructure store 213 which comprises a number of default content handling decision substructures. The default content handling decision substructures are in the example limited decision structures which have been determined based on previous content item handling operations and specifically based on the manual actions performed by the user.

Specifically, the docking device 101 comprises a user operation processor 215 which continually monitors manual content handling operations performed by the user. In response to these operations, the user operation processor 215 generates default content handling decision substructures which are then stored in the substructures store 213.

For example, if the user operation processor 215 determines that the user tends to regularly move rock music items by a specific artist and received from a specific contact into a given subfolder of a specific user device, it may generate a substructure for rock music which includes a decision that if the content item is received from the specific contact and is by the specific artist then it should automatically be moved to the specific subfolder of the specific user device. The decision may be combined with other preferences to generate a substructure for rock music items which furthermore can reflect a prioritisation between conflicting actions. For example, if the user operation processor 215 determines that all music received from another contact is always moved to a different folder of the user device, it may generate a decision substructure tree which first evaluates the contact from which it has been received and if this is from the second contact, an executable action is generated to move it to the appropriate folder. If not, the decision tree substructure may continue along a branch to a node determining if the music is rock music, then to a node determining if it is the specific artist etc.

In some embodiments, the user may specifically enter user preferences and the user operation processor 215 may use this to determine a substructure tree. For example, a user may specify that he prefers all rock music by artist A to be forwarded to folder B of device C and that this preference is given priority level 5 (say). Similarly, he may specify that on Fridays all music should be sent to device D and that this preference is given a higher priority level of 8 (say). The user operation processor 215 may then generate a substructure for rock music which first evaluates if today is Friday. If so, an executable action to copy the content item to device D is included and the substructure ends with an open node to which other substructures may be appended (e.g. a substructure for classical music reflecting preferences for how to present specific music on different devices). If not, the substructure may include a decision evaluating whether the rock music is by the specific artist and if so an executable action is defined copying the music clip to device D, and a second executable action is defined for moving the music clip to the specific folder of device D (e.g. by device D). The substructure then continues with an open branch to which other substructures may be appended.

It will be appreciated that the above simple examples have been provided for clarity and brevity and that many and complex substructures may be generated reflecting complex operations, actions and preferences.

The structure generation processor 211 is arranged to dynamically generate the content handling decision structure for the specific content item. Thus, the content handling decision structure may be generated such that it depends on the specific data received for the content item. For example, the rock music substructure may only be included if the received content item is identified as being a music content item.

For clarity the above description has focussed on a sequential operation of the involved processors. It will be appreciated that the operation may be iterative and interrelated. For example, the inference processor 203 may begin evaluating a content handling decision structure which initially only includes the top hierarchical layers, and the decision structure processor 205 and structure generation processor 211 may dynamically generate and provide appropriate substructures if and when they are needed.

Thus, the inference processor 203, the decision structure processor 205 and structure generation processor 211 provide a complex system which provides a dynamic inferencing model reflecting a potentially large number of user preferences as well as a variety of different data relating to the circumstances of the data. The inferencing model dynamically and automatically prioritises between different disparate preferences and provides output data which is consistent and free of conflicting actions.

The approach allows for very complex handling operations to automatically be generated reflecting very complex and potentially conflicting preferences. However, as the inferencing model is aimed at providing operations which reflect the operations that are most likely to be of interest to the user during normal operation, the docking device 101 furthermore comprises an exception processor 217 which is arranged to monitor if exceptional or extreme situations occur where the normal preferred operation as determined by the content handling decision structure should preferably not be performed.

For example, an evaluation of the content handling decision structure for a given content item may result in a given action that the content item should be moved to device A as this is the preferred operation. However, in situations where the storage capacity of device A is already fully used, the normally preferred action would result in the content item being lost. Thus, in this example, the exception processor 217 may detect that an exceptional situation has occurred and that the normal operations should be replaced by suitable exception operations, such as moving the content item to another device.

Specifically, the exception processor 217 comprises a set of exception rules where each exception rule links an executable action with a set of conditions for applying the executable action.

The exception rule may specifically be provided manually by the user (such as whenever a picture of my baby is identified make a back-up copy on device A unless there is one already) or may be defined during the design stage (such as do not delete source file if storage capacity of destination is insufficient).

Thus, each exception rule may e.g. be determined as:

IF<condition A> and <condition B> OR<condition C> then perform action A

The exception processor 217 may continuously monitor the operation of the inference processor 203 to determine if the conditions of any of the exception rules are met. For example, for each decision point of the content handling decision structure (e.g. each decision node of a decision tree), the exception processor 217 may compare the current conditions against the conditions of all exception rules.

The exception processor 217 then determines a set of applicable exception rules from the set of exception rules based on the current conditions which inherently relate to the context data and the content characterising data for the content item (for example this data determines the current location in the decision structure).

Typically, the set of exception rules will be empty, i.e. the conditions do not match the conditions of any of the exception rules. However, sometimes the conditions of one or more of the exception rules may be met. For example, a picture of the user's baby has been received but the storage of the photo back-up device is already full).

In such a case, the exception processor 217 proceeds to override a decision of the content handling decision structure. For example, the decision to move the photo to the photo back-up is overridden. The decision may for example be overridden by removing the corresponding executable action from the handling data or by replacing it with another action (such as copy to a different photo back-up device).

Thus, the docking system comprises parallel and relatively independent decision processes which allow very complex and intricate inferencing to be used to automatically generate complex and accurate handling procedures which automatically adapt to the user's implicit or explicit preferences while at the same time providing a very simple and efficient means of monitoring and controlling the inferencing to provide specific performance in specific situations.

The conditions evaluated by the exception rules may directly relate to the context data or content characterising data provided for the content item. However, the conditions may additionally or alternatively comprise considerations of data which is generated by the inference processor 203 while progressing through the content handling decision structure. For example, decision nodes may generate data depending on the outcome of the decisions. Such data will indirectly depend on the context and content characterising data and thus the conditions evaluated by the exception rules may indirectly depend on this data.

Thus, in the example, when a decision point of the content handling decision structure is evaluated by the inference processor 203, the exception processor 217 evaluates the conditions of all the exception rules and generates a set of applicable rules for that specific decision point. If the set is not empty, the exception processor 217 may proceed to override the specific decision by one or more executable actions defined by the exception rules. For example, an action to store a content item on device A may be overridden by an action to store it on device B if the exception rules determine that device A has no spare storage capacity.

The exception rule may further define a continuation point in the content handling decision structure. E.g., if an exception rule is applied to store a content item on device B rather than device A, a substructure of the content handling decision structure dealing with where to store the content item on device A may be bypassed and the evaluation of the content handling decision structure may continue at the exit node of this structure. Thus, the exception rules may also be used to control the operation of the complex inferencing mechanism and may for example shift the progress from one area of the content handling decision structure to potentially a completely different area.

In some situations the conditions of a plurality of exception rules will be met and thus the set of applicable exception rules may comprise a plurality of exception rules. In such a situation, the exception processor 217 can evaluate which of the exception rules should be applied and in particular it may prioritise between conflicting rules.

In the specific example, the exception processor 217 determines an applicability weight for each exception rule of the set of applicable exception rules. The applicability weight may indicate how closely the current data matches the conditions of the exception rule.

Specifically, the exception processor 217 matches the current conditions to the set of conditions for the exception rule. For example if an exception rule comprises a set of alternative conditions, such as

. . . <data A=Z> OR<data B=Y> OR<data C=X> OR<data D=W>

the exception processor can evaluate how many of the conditions are met. The more alternative conditions that are met, the higher the applicability weight. Thus, if the data of the content handling decision structure (including the content characterising data and the context data) currently has the data values of A=Z; B=M; C=X; D=W the applicability weight is higher than if the data values of A=Z; B=M; C=N; D=O.

Furthermore, in many situations only partial data may be available. For example, some exception rules may depend on context data (say time of content item generation) which may not be available. When determining the applicability weight for rules, missing data may e.g. be treated as corresponding to non-matching data. E.g. in the example above, if Data A is not available this will be treated as data A#Z.

When applying the exception rules of the set of applicable exception rules, the exception processor 217 may then select which rule(s) to apply depending on the applicability weights. For example, the exception processor 217 may execute only the exception rule having the highest weight. As another example, the exception processor 217 may determine which exception rules are mutually exclusive and may select one exception rule of mutually exclusive rules based on the applicability weights. As another example, the exception processor 217 may arrange the order in which the exception rules are applied depending on the applicability weight.

The use of exception rules provides an efficient and user friendly approach to controlling and restricting the operation of the inference mechanism used to generate the executable actions. For example, exception rules may be included which include a condition for a content item handling resource. For example, the condition may evaluate whether the resource required for performing a specific action is available. If not, the exception rule may define another action. For example, if the content item storage capability of a device is below the value required for storing a specific content item, the exception rule can define that the actions to store the content item on this device should be replaced by actions to store the content item on a different device.

As another example, the exception rules may provide an efficient means of ensuring that exceptional user preferences are treated properly. The inference mechanism is a complex algorithm which includes considering a large number of potential user preferences derived from a large number of similar content items. For example, the inference mechanism balances conflicting preferences such as music should be stored on device A and all content items from a given source should be stored on device B when receiving a music content item from this specific source. However, some user preferences may be particularly strong and the user may prefer these to take precedence over all other preferences. Such preferences, are difficult to control in a complex inferencing algorithm which inherently is based on the balancing of different preferences using dynamic and complex interactions between these. However, the user may simply specify an exception rule which will override the behaviour of the inference mechanism to provide the desired action. For example, the user may simply specify that all content items from a specific source should always be moved to device B. The exception processor 217 will then ensure that this preference always takes priority and that content items from the specific source are always moved to device B.

It will be appreciated that in the docking device of FIGS. 1 and 2, the content data receiver 201 provides means for receiving first context data and first content characterising data for a content item. Such means may for example be a receiver for receiving a data communication from a remote source, such as a radio receiver or a network interface (e.g. an interface to a local area network or the Internet). As another example, the content data receiver 201 may be a receiver for receiving data from an internal source, such as a data processor, program and/or electronic circuitry arranged to retrieve the context data and content characterising data from an internal memory.

Similarly, it will be appreciated that the decision structure processor 205 (optionally in combination with the structure generation processor 211 and/or the substructure store 213) provides means for providing a content handling decision structure associating context data and content characteristic data with content handling executable actions in response to a user preference profile. These means may for example be implemented as an executable routine implemented in a processing unit such as e.g. a micro-controller, a digital signal processor and/or a central processing unit. Specifically, the functionality of each processor may be implemented as a subroutine executed on the same processing unit. Also, the substructure store 213 may be implemented as a suitable memory element, such as solid state memory (ROM, RAM, Flash memory etc), magneto and/or optical storage devices (hard disk, optical disc etc).

Likewise, it will be appreciated that the inference processor 203 provides means for generating a set of executable handling actions for the content item by evaluating the content handling decision structure in response to the first context data and the first content characterising data and that the data generation processor 207 provides means for generating content handling data for the content item. These means, as indeed all processors illustrated in FIG. 2, may be implemented as different unique sets of programming instructions that are executed on one processor (or distributed over a plurality of processors), or can each be electronic circuitry such as a custom large scale integrated circuit state machine (or part of one). As another example, the processors may be implemented partly or fully as neural networks and/or fuzzy computing.

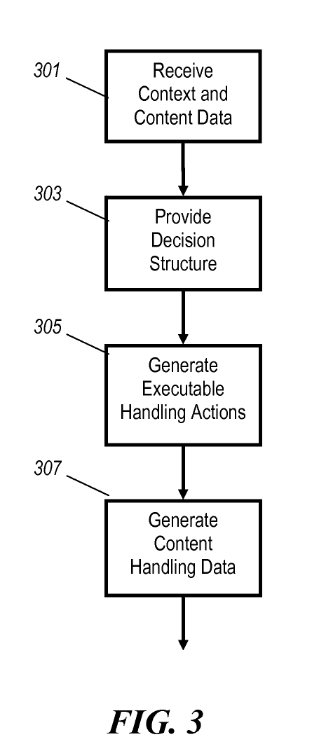

FIG. 3 illustrates a method of generating content handling data for a content item in accordance with some embodiments of the invention.

The method initiates in step 301 wherein first context data and first content characterising data is received for a content item.

Step 301 is followed by step 303 wherein a content handling decision structure associating context data and content characteristics data with content handling executable actions in response to a user preference profile is provided. The content handling decision structure reflects allowable interrelations between content handling actions.

Step 303 is followed by step 305 wherein a set of executable handling actions is generated for the content item by evaluating the content handling decision structure in response to the first context data and the first content characterising data.

Step 305 is followed by step 307 wherein content handling data for the content item is generated. The content handling data comprises the set of executable actions.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating content handling data for a content item, the method comprising:
receiving first context data and first content characterising data for a content item;
providing a content handling decision structure associating context data and content characteristic data with content handling executable actions in response to a user preference profile, the content handling decision structure furthermore reflecting allowable interrelations between content handling actions;
generating a set of executable handling actions for the content item by evaluating the content handling decision structure in response to the first context data and the first content characterising data; and
generating content handling data for the content item, the content handling data comprising the set of executable actions.

2. The method of claim 1 further comprising communicating the content item to a remote device out of a plurality of remote devices in response to the content handling data comprising an executable action specifying a communication of the content item to the remote device.

3. The method of claim 2 wherein the content handling decision structure furthermore associates content handling actions in response to a device profile associated with the remote device.

4. The method of claim 1 wherein the content handling decision structure furthermore associates content handling actions in response to a device profile associated with a source device of the content item.

5. The method of claim 1 wherein the content handling decision structure furthermore associates content handling actions in response to a user characteristics profile.

6. The method of claim 1 wherein the user preference profile comprises at least one user preference selected from the group consisting of:
a content distribution preference;
a user contact preference; and
a grouping preference.

7. The method of claim 1 wherein the content handling decision structure comprises a decision tree.

8. The method of claim 1 further comprising generating the content handling decision structure by combining default content handling decision substructures in response to at least one of the first context data and the first content characteristics data.

9. The method of claim 8 further comprising generating at least one of the default content handling decision substructures in response to previous content handling user behaviour.

10. The method of claim 8 further comprising generating at least one of the default content handling decision substructures in response to a user preference.

11. The method of claim 1 further comprising:
providing a set of exception rules, each exception rule associating an executable action with a set of conditions for applying the executable action;
determining a set of applicable exception rules from the set of exception rules in response to at least one of the first context data and the first content characterising data; and
overriding a decision of the content handling decision structure in response to a first exception rule of the set of applicable exception rules.

12. The method of claim 11 wherein the step of determining the set of applicable exception rules comprises determining a set of applicable exception rules for each decision point of the content handling decision structure and the step of overriding comprises overriding a decision of the decision point by an exception rule from the set of applicable exception rules for the decision point unless the set of applicable exception rules is empty for the decision point.

13. The method of claim 11 wherein at least one exception rule of the set of exception rules defines a continuation point in the content handling decision structure.

14. The method of claim 11 wherein the step of determining the set of applicable exception rules comprises determining an applicability weight for each exception rule of the set of applicable exception rules and wherein the step of overriding comprises selecting the first exception rule in response to the applicability weights.

15. The method of claim 14 wherein the step of determining the set of applicable exception rules comprises determining the applicability weight for each exception rule in response to a match between current conditions and the set of conditions for the exception rule.

16. The method of claim 11 wherein at least one exception rule of the set of exception rules comprises a set of conditions including a condition for a content item handling resource.

17. The method of claim 16 wherein the content item handling resource is a content item storage capability.

18. The method of claim 11 wherein at least one exception rule of the set of exception rules comprises a set of conditions including a condition for a user preference.

19. A content item apparatus comprising:
means for receiving first context data and first content characterising data for a content item;
means for providing a content handling decision structure associating context data and content characteristic data with content handling executable actions in response to a user preference profile, the content handling decision structure furthermore reflecting allowable interrelations between content handling actions;
means for generating a set of executable handling actions for the content item by evaluating the content handling decision structure in response to the first context data and the first content characterising data; and
means for generating content handling data for the content item, the content handling data comprising the set of executable actions.
